(19) United States
(12) Patent Application Publication
(10) Pub. No.: US 2001/0023418 A1
(43) Pub. Date: Sep. 20, 2001

(54) Method and apparatus for estimating product cost

(76) Inventors: Noriyasu Suzuki, Kariya-city (JP); Jinichi Uchida, Nagoya-city (JP); Takeshi Funada, Kosai-city (JP)

Correspondence Address: Larry S. Nixon, Esq., NIXON & VANDERHYE P.C., 1100 North Glebe Rd, 8th Floor, Arlington, VA, 22201-4714, US

(21) Appl. No.: 09/768,462

(22) Filed: Jan. 25, 2001

(30) Foreign Application Priority Data
Mar. 15, 2000 (JP) 2000-72904

(51) Int. Cl. G06F 19/00

(52) U.S. Cl. 705/400; 700/96; 700/97

(57) ABSTRACT

A storage device of a design data server stores geometrical data (e.g., dimensions, surface area, volume and the like) and the attribute data (e.g., product material name and the like) of the product. When an operator performs a CAD operation through a CAD system, cost factor data are automatically acquired from the geometrical data and the attribute data stored in the storage device of the design data server through an automatic acquisition feature of the CAD system. A cost of the product is computed based on the cost factor data and is displayed on the CAD terminal.

### CROSS REFERENCE TO RELATED APPLICATION

This application is based on and incorporates herein by reference Japanese Patent Application No. 2000-72904 filed on Mar. 15, 2000.

### BACKGROUND OF THE INVENTION

The present invention relates to a method and apparatus for estimating a cost of a component product by use of a database that contains, for example, manufacturing conditions of a manufacturing facility, manufacturing time, required expenses and other cost factors necessary for manufacturing the component product.

In estimating product cost, an operator manually collects necessary data (e.g., product sizes and the like) to be inputted to the cost estimation system based on drawings of the component product, a prototype model of the component product, similar component products available in the market and the like. These necessary data are collected by computations with a calculator, direct measurements with measurement devices or predictions. After these data are collected and inputted to the cost estimation system, the cost estimation system computes the cost of the component product. Thus, the cost estimation system requires two operations, i.e., the data collecting operation and the data input operation. These operations require some cost estimation expertise. Also, these operations are time consuming and are prone to human error.

Furthermore, the cost estimation system is operated independently from a design system, such as a computer-aided design (CAD) system, which is used for inputting and registering design data and which has no feature for computing the data required for the cost estimation.

To address the above-described disadvantages, for example, Japanese Unexamined Patent Publication No. 9-231265 discloses a cost estimation system that retrieves the data required for the cost estimation from a CAD system and uses the retrieved data as its input data. However, in this system, it is difficult to retrieve sufficient data for computing the cost from the CAD system. Furthermore, while the CAD system is primarily operated to design the component product, the cost estimation through the cost estimation system can not be conducted in real time.

### SUMMARY OF THE INVENTION

The present invention addresses the above-described disadvantages. Therefore, it is an objective of the present invention to provide a method and apparatus for estimating a cost of a product capable of allowing an operator having no substantial cost estimation expertise to carry out the cost estimation with higher speed and accuracy.

To achieve the objective of the present invention, there is provided a method for estimating a cost of a product. Cost factor data of the product, which include cost factors and values of the cost factors, are retrieved and displayed. The cost factor data of the product include at least one of geometrical data (e.g., dimensions, surface area and volume) and attribute data (e.g., product material name) of the product. These data are contained in design data of the product produced by a CAD system. At least one of the values of the cost factors is acquirable by an automatic data acquisition feature of the CAD system through operation of the CAD system conducted by an operator. The cost of the product is computed based on the cost factor data.

Furthermore, a cost estimation apparatus for estimating a cost of a product is provided to achieve the objective of the present invention. The cost estimation apparatus includes a storage device, a first acquisition device, a second acquisition device, a cost computing device and a display device. The storage device stores geometrical data (e.g., dimensions, surface area and volume which defines a shape) and attribute data (e.g., product material name) of the product produced by a CAD system. The first acquisition device automatically acquires values of cost factors of the product from the geometrical data and the attribute data stored in the storage device. The second acquisition device acquires at least one of the values of the cost factors by an automatic data acquisition feature of the CAD system through operation of the CAD system conducted by an operator. The cost computing device computes the cost of the product based on cost factor data including the cost factors and the values of the cost factors acquired by the first and second acquisition devices. The display device displays the cost computed by the cost computing device.

### BRIEF DESCRIPTION OF THE DRAWINGS

The invention, together with additional objects, features and advantages thereof, will be best understood from the following detailed description, the appended claims and the accompanying drawings in which:

FIG. 1 is a schematic structural view of a cost estimation apparatus according to an embodiment of the present invention;

FIG. 2 is a schematic functional view of another type of cost estimation apparatus different from the present embodiment shown in FIG. 1;

FIG. 3 is a schematic functional view of a prior art cost estimation apparatus;

FIG. 4 is a flow chart showing one portion of a cost estimation process according to the embodiment of the present invention;

FIG. 5 is a flow chart showing another portion of the cost estimation process according to the embodiment of the present invention;

FIG. 6 is a flow chart showing another portion of the cost estimation process according to the embodiment of the present invention;

FIG. 7 is a perspective view of a component product displayed on a three-dimensional CAD screen;

FIG. 8 is a view showing a menu for selecting a processing type;

FIG. 9 is a view showing a dialog menu of an injection molding;

FIG. 10 is a view showing a menu for retrieving a cost factor data file;

FIG. 11 is a three-dimensional CAD screen view showing length, width and height of the component product;

FIG. 12 is a schematic view showing computation of the length, the width and the height of the component product shown in FIG. 11;

FIG. 13 is a schematic view showing re-measurement of wall thickness of the component product;

FIG. 14 is a schematic view showing measurement of the wall thickness;

FIG. 15 is a partial perspective view of the component product displayed on the three-dimensional CAD screen; and

FIG. 16 is a view showing results of the cost estimation according to the embodiment of the present invention.

### DETAILED DESCRIPTION OF THE INVENTION

An embodiment of the present invention will now be described with reference to the accompanying drawings.

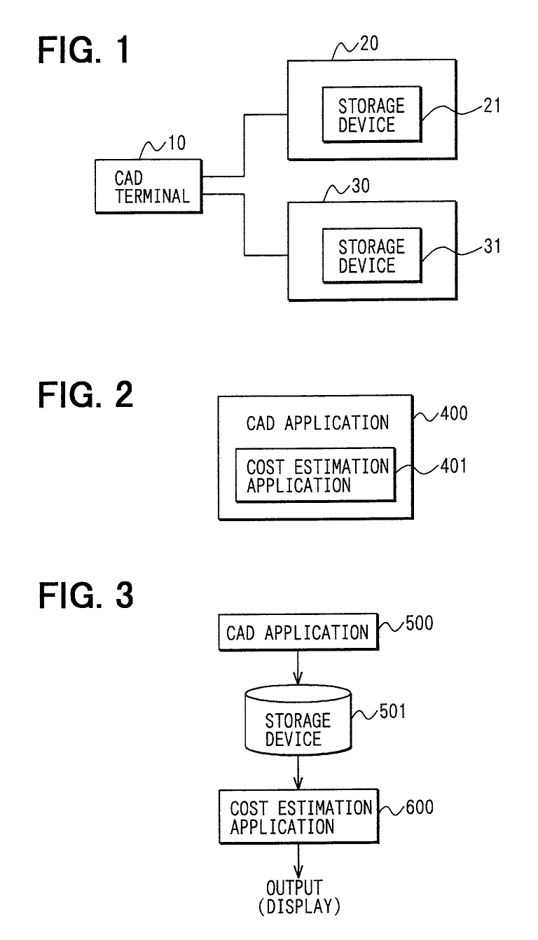

With reference to FIG. 1, a cost estimation apparatus of the present embodiment includes a CAD terminal 10 of a CAD system, a design data server 20 and a cost estimation server 30. The CAD terminal 10 includes a display device, input devices (e.g., a keyboard and a pointing device, such as a mouse, a digitizer, a tablet or the like), a central processing unit (CPU) and a storage device (memory device). The CAD terminal 10 is interconnected with the design data server 20 and the cost estimation server 30. The CAD system of the present embodiment is a three-dimensional CAD system for designing a three-dimensional product model. The design data server 20 includes a storage device (memory device) 21, a CPU, a network device (e.g., a network board or the like). Similarly, the cost estimation server 30 includes a storage device (memory device) 31, a CPU and a network device (e.g., a network board or the like).

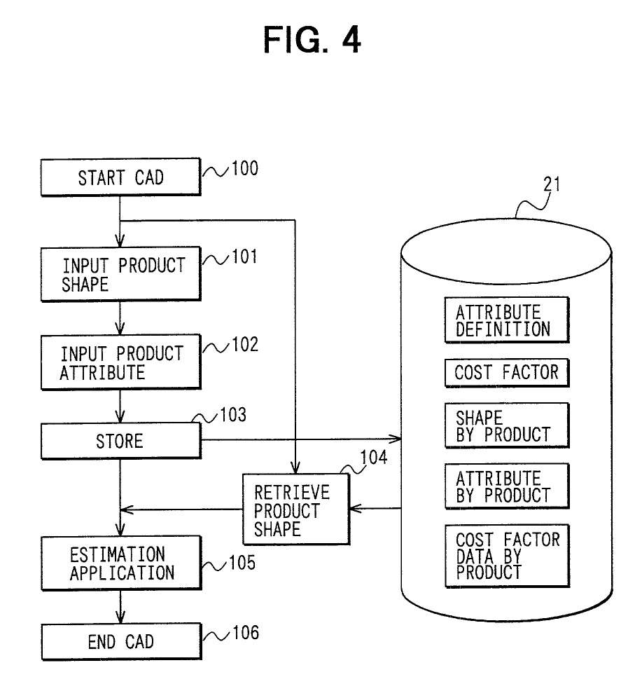

As shown in FIG. 2, a CAD application 400 of the present embodiment includes a cost estimation application 401. That is, unlike a cost estimation application 600 shown in FIG. 3 that is connected to a storage device (memory device) 501 provided for storing data produced by a CAD application 500, the cost estimation application 401 of the present embodiment is implemented in the CAD system to compute a product unit cost based on design data of the product produced by the CAD system. Thus, the product unit cost can be estimated for the product that is currently displayed on the CAD system. That is, in the CAD system, all the operations required for the cost estimation starting from an acquisition operation for acquiring cost factor data to a display operation for displaying the estimated cost can be conducted for the product currently displayed by the CAD system.

Furthermore, the design data of the product can be inputted through the CAD terminal 10 shown in FIG. 1. The inputted design data are stored in the storage device 21 of the design data server 20. The storage device 21 stores not only the design data produced by the CAD but also other design data in an appropriate fashion. The registered data of the CAD system include geometrical data of the product (e.g., dimensions, surface area, volume and the like) as well as the attribute data of the product (e.g., product name, product number, product material name and the like). In the CAD terminal 10, the cost factor data are automatically retrieved from the storage device 21 of the design data server 20, and the retrieved cost factor data can be displayed on the display device of the CAD terminal 10. Furthermore, in the CAD terminal 10, (i) the retrieved cost factor data can be further changed or added as required, and (ii) the manufacturing conditions can be manually specified instead of automatically predicting them.

More specifically, in the operation of (i), if values of the cost factors displayed on the display device of the CAD terminal 10 need to be changed, the CAD terminal 10 can automatically compute and set these values after the corresponding CAD operation is performed by the operator. Alternatively, in the CAD terminal 10, the values of the cost factors can be manually set by the operator through the keyboard, the mouse or the like. Furthermore, in the operation of (ii), although the cost estimation apparatus has a manufacturing step prediction feature for predicting standard manufacturing steps, the operator can manually specify each manufacturing step without using the manufacturing step prediction feature. In this way, the cost can be computed for the standard manufacturing steps and also for the individually specified manufacturing steps.

In the cost estimation server 30, the cost factor data are received from the CAD terminal 10, and the manufacturing steps and manufacturing facilities are automatically predicted based on the cost factor data. Then, based on the manufacturing conditions, the cost estimation server 30 estimates the cost. More specifically, the storage device 31 of the cost estimation server 30 stores the cost factor data, a manufacturing step prediction database, manufacturing step prediction rules, a cost computation database and cost computation rules. Standard manufacturing steps are predicted based on the manufacturing step prediction rules. Then, a processing cost of each predicted manufacturing step is estimated by following the cost estimation rules based on the cost factor data and the cost computation database. The most cost effective manufacturing steps are determined based on the estimated processing costs. These results are sent to the CAD terminal 10 and are displayed on the CAD terminal 10.

The cost estimation apparatus of the present invention also has a feature to retrievably store the current cost factor data to allow a re-estimation of the product under the same conditions later on. The cost estimation apparatus can be operated on a read-only CAD system (e.g., a viewer) that does not allow modification of the design data but allows retrieval of the design data from it.

The present embodiment will now be described with an exemplary cost estimation process of a molded resin component product.

(A) Cost Factors of a Molded Resin Component Product

The molded resin component product in this instance is a component product that is manufactured by injection molding of thermoplastic resin material through a horizontal injection molding machine. The cost to be estimated is a component product unit cost including a material cost, a processing cost (including an injection molding cost, a finishing cost and a thermo-processing cost) and a die cost per component product. The product unit cost can be given by the following equations:

Product Unit Cost=Material Cost+Processing Cost+Die Cost;

and

Processing Cost=Injection Molding Cost+Finishing Cost+Thermo processing cost.

The cost estimation of the molded resin component product can be carried out by one of two ways, i.e., a cumulative estimation and a statistical estimation. In the cumulative estimation, a cost required for each manufacturing step of the product is cumulated to give a total cost for all manufacturing steps In the statistical estimation, a recursive equation or the like is produced through a statistical process based on the cost factors and the previous costs, and a cost is computed through the recursive equation. In the present embodiment, the processing cost is computed through the cumulative estimation, and the die cost is computed through the statistical estimation.

When the cost factor data are provided, the product unit cost is automatically computed and outputted through the cost estimation application shown in FIG. 2 based on the manufacturing step database, the cost database, the manufacturing step prediction rules and the cost computation rules. Thus, the cost factor data need to include all necessary data required to determine the product unit cost.

The cost factor data will be further described in greater detail below.

(1) Manufacturing Step Prediction Part

The manufacturing step prediction in this instance is the prediction of a relationship between the intended manufacturing facility for the injection molding and the number of component products being molded in the die per molding cycle.

In the manufacturing step prediction part, the following cost factors are required. If such cost factors are available, the relationship between the intended manufacturing facility and the number of the products being molded in the die per molding cycle can be predicted based on the manufacturing step prediction rules and the manufacturing step database. The cost factors include:

(a) a net volume of the product;

(b) a projected net surface area seen in a releasing direction of the product that is the moving direction of the product being released or pulled out from the die after molding;

(c) a length of an imaginary rectangle that covers the entire product as seen in the releasing direction of the molded product;

(d) a width of the imaginary rectangle that covers the entire product as seen in the releasing direction of the product;

(e) a maximum size of the molded product in the releasing direction of the product;

(f) presence of any undercut portions in the product;

(g) the number of the undercut portions;

(h) a sliding direction of a slidable die required to mold each undercut portion;

(i) a surface area of each undercut portion as seen in the sliding direction of the slidable die; and

(j) a slide stroke length of the slidable die required for manufacturing each undercut portion of the product.

(2) Cost Computation Part

(2-1) Material Cost

In the cost computation part, if the following cost factors are available, the material cost can be computed based on material cost computation rules and a material database. The cost factors include:

(a) a net volume of the product;

(b) a type of product material; and

(c) a type of runner used for the injection molding of the product.

(2-2) Injection Molding Cost

In the cost estimation part, if the following cost factors are available, the injection molding cost can be computed based on the processing cost computation rules for the injection molding and a cost database. The cost factors include:

(a) the number of production lots;

(b) a manufacturing capacity of the intended manufacturing facility;

(c) the number of products being molded in the die per molding cycle;

(d) a wall thickness (an average wall thickness of the product);

(e) the type of product material;

(f) the length of the imaginary rectangle that covers the entire product as seen in the releasing direction of the product;

(g) the width of the imaginary rectangle that covers the entire product as seen in the releasing direction of the product;

(h) the maximum size in the releasing direction of the product;

(i) presence of any inserts;

(j) the number of the inserts; and

(k) a coefficient indicating a degree of handling difficulty of each insert which may be determined based on a directionality of the insert that is mainly governed by a shape of the insert, wieldy of the insert or the like.

(2-3) Finishing Cost

In the cost estimation part, if the following cost factors are available, the finishing cost can be computed based on the finishing cost computation rules and the cost database. The cost factors include:

(a) the length of the imaginary rectangle that covers the entire product as seen in the releasing direction of the product;

(b) the width of the imaginary rectangle that covers the entire product as seen in the releasing direction of the product;

(c) the type of runner used for the injection molding of the product; and

(d) a finishing precision of a gate.

(2-4) Thermo-Processing Cost

In the cost computation part, if the following cost factors are available, the thermo-processing cost can be computed based on the thermo-processing cost computation rules and the cost database. The cost factors include:

(a) the length of the imaginary rectangle that covers the entire product as seen in the releasing direction of the product;

(b) the width of the imaginary rectangle that covers the entire product as seen in the releasing direction of the product;

(c) the maximum size in the releasing direction of the product;

(d) a thermo-processing temperature; and

(e) thermo-processing time.

(2-5) Die Cost

In the cost computation part, if the following cost factors are available, the die cost can be computed based on the die cost computation rules and the cost database. The cost factors include:

(a) the number of production lots;

(b) the number of products being molded in the die per molding cycle;

(c) the length of the imaginary rectangle that covers the entire product as seen in the releasing direction of the product;

(d) the width of the imaginary rectangle that covers the entire product as seen in the releasing direction of the product;

(e) the maximum size of the molded product in the releasing direction of the product;

(f) a coefficient indicating complexity and precision of the product which may be determined based on the complexity and the required precision of the product shape;

(g) the type of runner used for the injection molding of the product;

(h) the type of product material;

(i) presence of any undercut portions in the product;

(j) the number of the undercut portions;

(k) a sliding direction of a slidable die required to mold each undercut portion;

(l) a surface area of each undercut portion as seen in the sliding direction of the slidable die; and

(m) presence of threads in the product.

(B) Method for Acquiring Values of Cost Factors

After acquiring the above-described cost factors, the manufacturing step prediction and the cost computation are carried out based on the values of the cost factors. The method for acquiring the values of the cost factors will be described below.

(1) Automatic Acquisition from the Registered Data of the CAD System

The method for automatically acquiring the values of the cost factors is needed to avoid manual work.

In the CAD system of the present embodiment, upon completion of the product design, values of the product dimensions and values of the product attributes (e.g., the product name, the product number, a material symbol indicating a product material name, a post-process symbol indicating a process required after the molding or the like) are registered or stored.

The material is selected from the material database, and the post-process is also selected from a post-process database. Thus, the material symbol or the post-process symbol can be used to search specific material data or the specific post-process data through the corresponding database, allowing automatic acquisition of the specific data.

Thus, the cost estimation application 401 of FIG. 2 includes a cost factor value retrieval feature to retrieve the values of the cost factors directly from the registered data in the CAD system and also includes a cost factor value computation feature for computing the values of the cost factors based on the registered data retrieved from the CAD system, allowing automatic acquisition of the cost factor data.

(2) Acquisition Through the Operation of the CAD System

During the course of the cost estimation, the automatically acquired values of the cost factors may need to be modified. Furthermore, due to some technical difficulties or due to incompleteness of the database, it is not always possible to get values of the cost factors automatically in the above-described manner. In such a case, there are two possible ways to get the values of the cost factors.

The first way is an automatic acquisition through the operation of the CAD system. For instance, the previously registered data include the releasing direction of the product. If there is a demand to change the releasing direction to reduce the product unit cost, it is possible to simulate various releasing directions by operating the CAD system, and the cost estimation can be carried out for each direction to see whether the product unit cost can be reduced by changing the releasing direction.

In another instance, if the product has a protrusion, and if there is a demand to remove the protrusion to reduce the product unit cost, it is also possible to simulate the product without the protrusion by operating the CAD system. The cost estimation can be carried out for the product without the protrusion to see whether the product unit cost can be reduced by removing the protrusion.

To meet the above-described demands, the cost estimation apparatus of the present embodiment has a feature to acquire the cost factor data through the operation of the CAD system. The operator performs only the CAD operation, and the values of the cost factors are automatically acquired or computed. This is different from a manual input operation (described in detail below) where the values of the cost factors are manually inputted.

(3) Acquisition Through a Manual Input Operation, for Example, Through the Operation of the Keyboard or the Mouse

The second way is the acquisition of the values of the cost factors through the manual input operation, for example, through the operation of the keyboard or the mouse. It is conceivable that the values of the cost factors are already known before operating the CAD system, and the manual input operation of the values of the cost factors can save more time than the above-described automatic acquisition by eliminating the time required for the computation. Furthermore, it is also conceivable that the product is an unusual product and thereby does not allow computation of the values of the cost factors through the above-described automatic acquisition.

To deal with such cases, the cost estimation apparatus has a manual acquisition feature for acquiring the values of the cost factors, for example, through the keyboard or the mouse (e.g., selecting an appropriate value of each cost factor from a selection list on the display screen with a mouse cursor).

More specific details (a flow of cost estimation process of the molded resin product) will be discussed with reference to FIGS. 4-6.

With reference to FIG. 4, at step 100, the operator starts the CAD system and opens a CAD file of the subject product or make a new CAD file of the subject product. Then, the operator inputs the geometrical data of the product as a product shape data at step 101 and then inputs attribute data of the product at step 102. Next, at step 103, the operator commands to save the geometrical data and the attribute data of the product. These data are sent to the storage device 21 of the design data server 20 and are stored therein as the geometrical data and the attribute data of the product. In this way, the geometrical data, such as dimensions, surface area, volume and the like of the product, as well as the attribute data, such as type of product material and the like are stored.

Once the CAD system is started at step 100, if the operator commands to retrieve the geometrical data of the product at step 104, the geometrical data of the corresponding product is retrieved from the storage device 21 of the design data server 20.

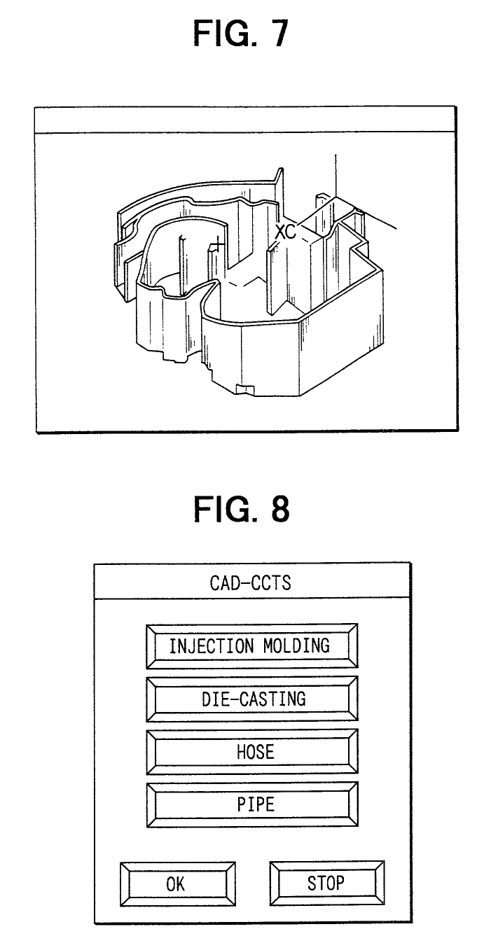

In the CAD terminal 10, while a component product file of the CAD is opened on the display screen as shown in FIG. 7, if the cost estimation application is executed at step 105 of FIG. 4, the cost of the product can be estimated based on the design data of the subject product collected by the CAD system.

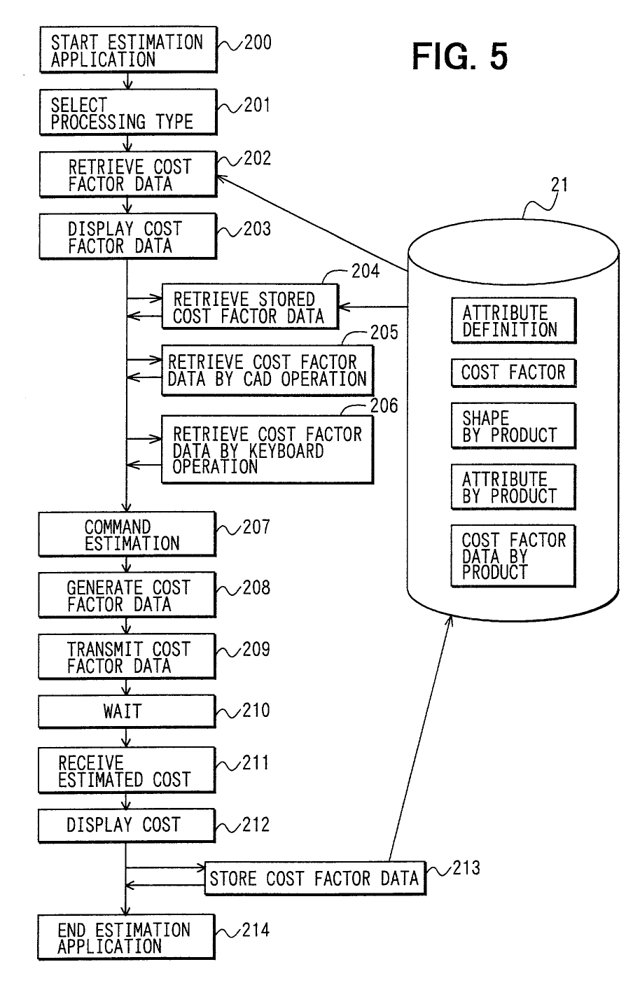

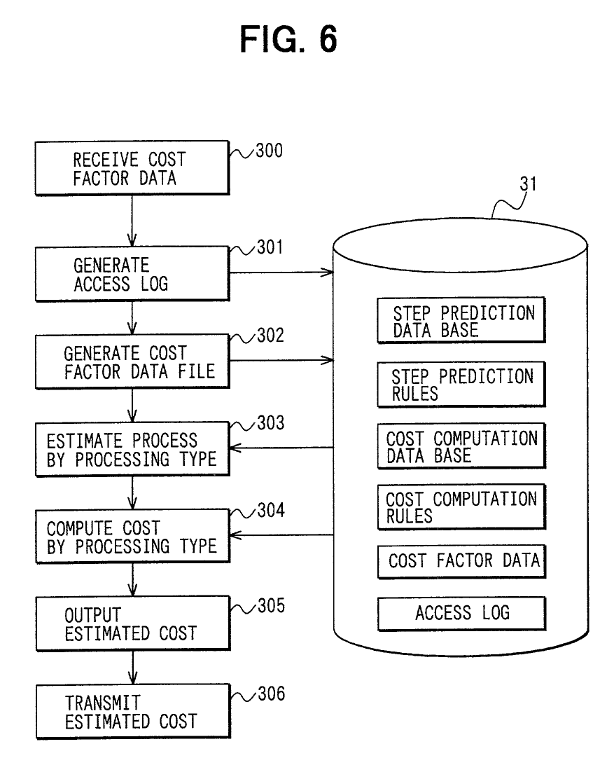

More specifically, at step 200 of FIG. 5, when the operator selects “COST ESTIMATION SYSTEM” from an application menu of the CAD system, the cost estimation application is started. At this stage, it is checked whether the operator is authorized to conduct the cost estimation, so that only the authorized operator is allowed to conduct the following cost estimation.

Then, at step 201 of FIG. 5, the operator selects a processing type (the subject product). More particularly, a list of processing types is displayed, and the operator selects one from the list. Specifically, as shown in FIG. 8, the operator selects “INJECTION MOLDING” from the menu screen.

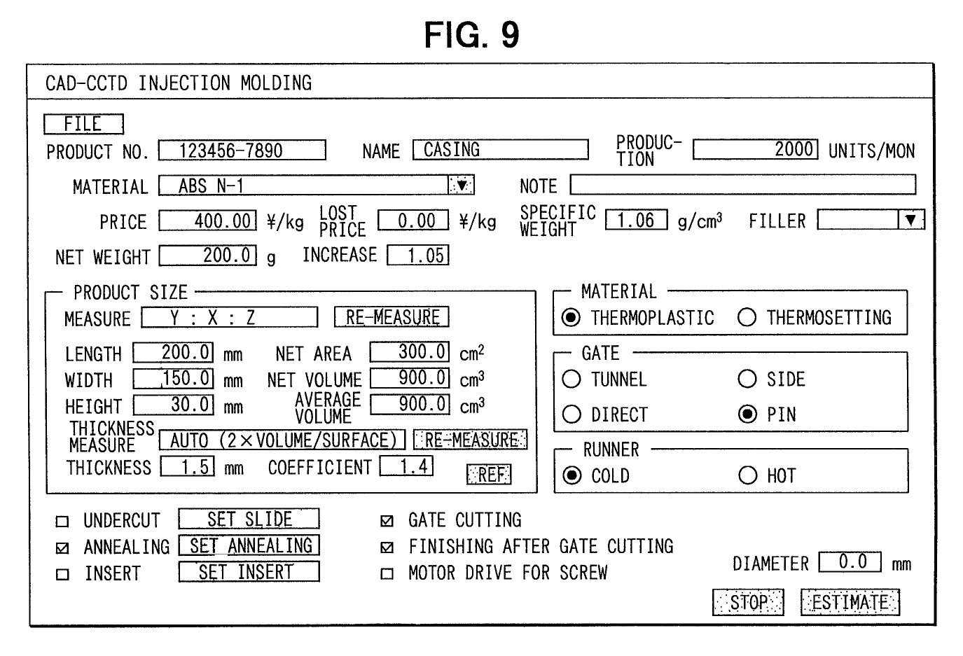

With this operation, at step 202 of FIG. 5, the cost factor data (the cost factor data of the corresponding product) are automatically retrieved from the storage device 21 of the design data server 20. Then, at step 203, the cost factor data are displayed on the display screen of the CAD terminal 10. More specifically, as shown in FIG. 9, the attribute data of the product, such as the product number, the product name, the product material name and the like, are retrieved from a component product database. Furthermore, dimensions of the product (e.g., length, width and height), projected net surface area of the product, net volume of the product, average interior volume of the die, wall thickness of the product, shape coefficient of the product and the like are retrieved and are set as initial values in corresponding cost factor display fields.

In this way, based on the design data of the subject product produced by the CAD system, the geometrical data including the dimensions, the surface area, the volume or the like as well as the attribute data including the material name are retrieved and are displayed as the cost factors.

FIG. 9 shows part of the retrieved values which can be displayed on the screen by a clicking operation of the mouse.

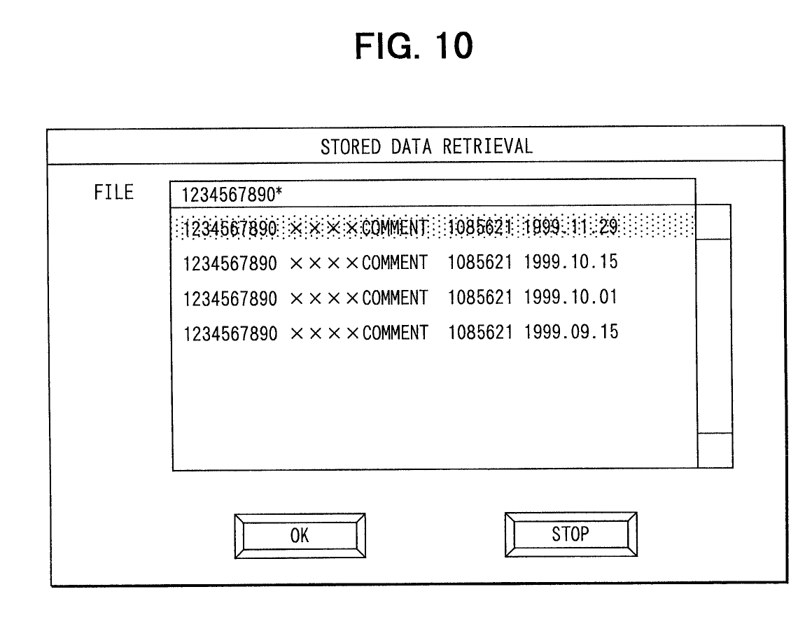

Furthermore, at step 204 of FIG. 5, the stored cost factor data are retrieved from the storage device 21 of the design data server 20 as required. That is, the cost factor data are loaded from a previously stored cost factor data file, and the cost factor data are changed. More specifically, when a “RETRIEVE STORED DATA” button (not shown in FIG. 9) on the processing type specific dialog menu is pressed or clicked, a screen shown in FIG. 10 is displayed. When a desired file is selected from displayed files on the screen, the values of the cost factors (FIG. 9) are retrieved from the file and are set.

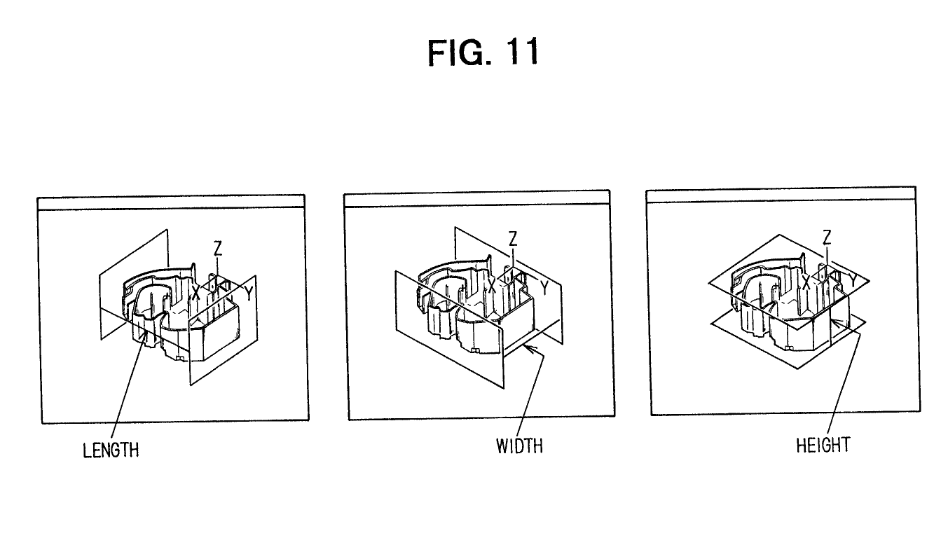

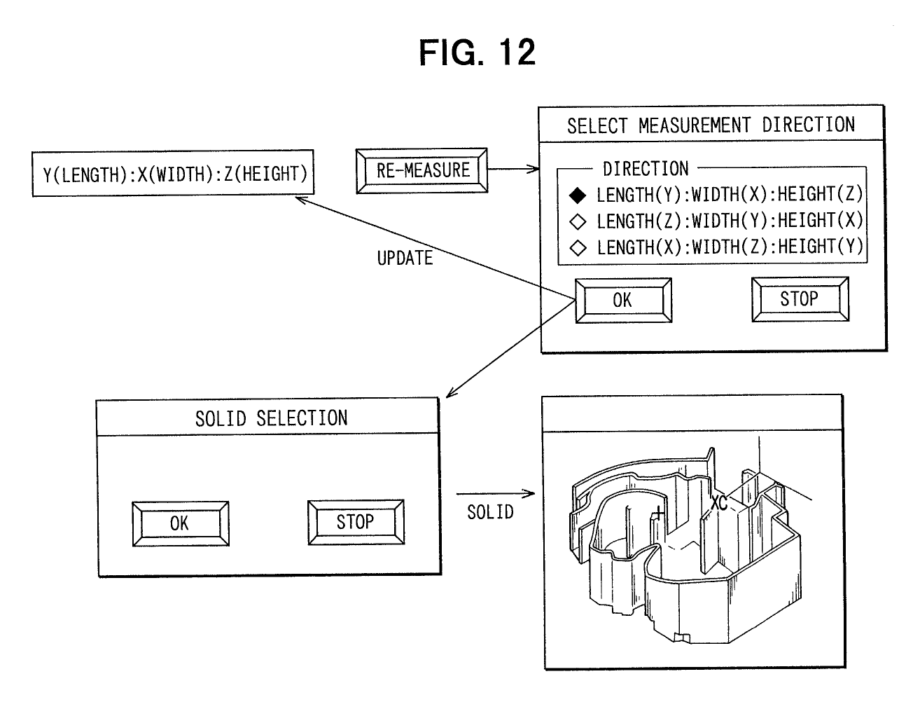

Furthermore, at step 205 of FIG. 5, the cost factor data are modified or added through the CAD operation as required. Specifically, for example, after the length, the width and the height of the product are defined on the three-dimensional screen of the three-dimensional CAD system as shown in FIG. 11, if a measurement direction is selected on a menu screen of FIG. 12, values of the length, the width and the height are automatically computed and are set in the corresponding cost factor value input fields shown in FIG. 9. As another instance, a process for acquiring the wall thickness of the product through the CAD operation will now be described.

Through the above-described automatic acquisition feature, a default value (initial value) of the wall thickness is obtained by the following equation:

Wall thickness=2×Product net volume÷product net surface.

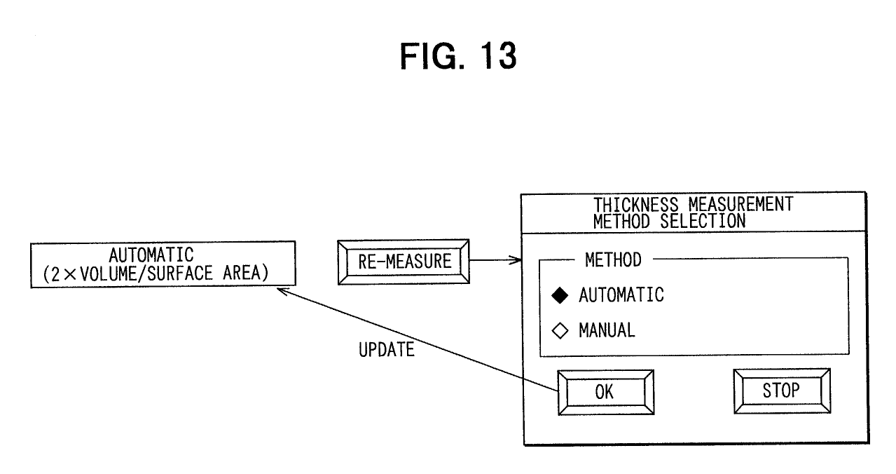

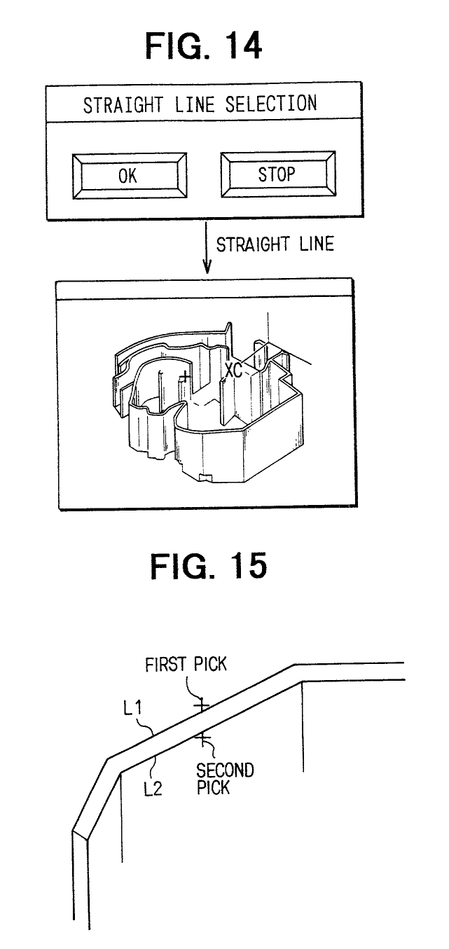

This default value is set in a wall thickness value input field. To modify the wall thickness by the operation of the CAD system, the operator first presses or clicks a “RE-MEASURE” button for re-measuring the wall thickness on the processing type specific dialog menu of FIG. 9 and also in a schematic diagram of FIG. 13. Then, the operator selects “STRAIGHT LINE” from a menu screen shown in FIG. 14 and picks a couple of points, i.e., lines L1, L2 to be measured shown in a model screen of FIG. 15 using the mouse. At this stage, when the wall thickness measurement is executed, the wall thickness between the line L1 and the line L2 is automatically computed, and the computed value of the wall thickness is set in the wall thickness value input field (FIG. 9).

Referring back to FIG. 5, at step 206, the cost factor data are inputted through the keyboard operation as required. That is, the cost factor data are modified or added by the manual input operation. During this operation, if the operator wants to skip the standard manufacturing step prediction performed by the manufacturing step prediction feature and wants to manually select the corresponding manufacturing step, the manufacturing step is inputted to the corresponding input field.

Furthermore, when the input by the CAD operation at step 205 and the manual input at step 206 in FIG. 5 are to be performed, if an input value of one cost factor input field governs an input value of other cost factor input field, the governed input value of the other cost factor input field is automatically renewed upon modification of the input value of the one cost factor input field.

Then, at step 207 of FIG. 5, the operator clicks an “ESTIMATE” button in the processing type specific dialog menu of FIG. 9 at step 207 of FIG. 5. As a result, in the CAD terminal 10, the cost factor data to be transmitted are collected at step 208, and the collected cost factor data are transmitted to the cost estimation server 30 at step 209. Thereafter, the CAD terminal 10 enters a hold or wait state at step 210.

With reference to FIG. 6, at step 300, the cost estimation server 30 receives the cost factor data. Then, an access log is generated at step 301, and a cost factor data file is generated at step 302. Then, the manufacturing step is predicted for the corresponding processing type at step 303, and the cost is estimated for that processing type at step 304. That is, the manufacturing step is predicted based on the manufacturing step database and the manufacturing step prediction rules. Based on the predicted manufacturing step, the cost is computed. The computed cost and relevant data are outputted at step 305 and are transmitted to the CAD terminal 10 at step 306.

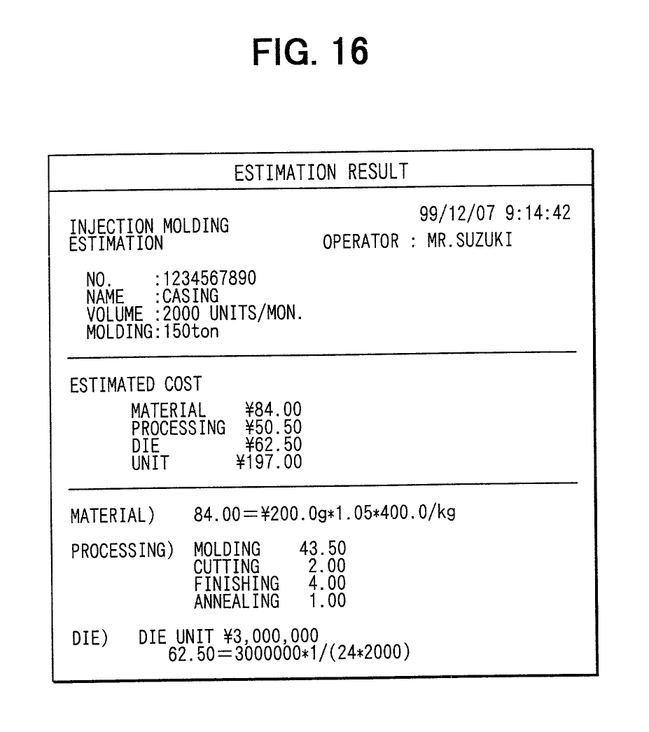

In the CAD terminal 10, at step 211 of FIG. 5, the computed cost data are received from the cost estimation server 30 and are displayed at step 212 (such as those shown in FIG. 16). On the screen of FIG. 16, the product number, the product name, the monthly production volume and the molding details (150 tons, 1 piece per molding cycle) are displayed. The material cost, the processing cost, the die cost and the product unit cost are also displayed.

Furthermore, if a “SAVE” button (not shown) in the processing type specific dialog menu is pressed or clicked at step 213 of FIG. 5, the cost factor data displayed on the dialog menu are stored in the storage device 21 of the design data server 20 as a data file. More particularly, the data are stored in a name specified by the operator.

Then, at step 214 of FIG. 5, the cost estimation application is closed (closing the processing type specific dialog menu). Next, the CAD system is terminated at step 106 of FIG. 4.

In the present embodiment, the operator can modify each manufacturing step condition. In the manufacturing step prediction operation, the corresponding manufacturing step is predicted based on the cost factor data of the manufacturing step specified by the operator, the manufacturing step database and the manufacturing step prediction rules. Then, in the cost computation operation, the product unit cost is computed based on the predicted manufacturing step. The manufacturing step condition modification operation will be described below.

The manufacturing step prediction operation in this instance is the operation that predicts the relationship between the intended facility and the number of the products being molded in the die per molding cycle as described earlier. Although the manufacturing step is predicted based on the cost factor data, the manufacturing step prediction rules and the manufacturing step database in the manufacturing step prediction operation, the intended facility and/or the number of the products being molded in the die per molding cycle can be specified in the cost factor data on the processing type specific dialog menu. This allows elimination of part of the manufacturing step prediction operation.

Then, the cost computation operation can be carried out. In such a case, if only the intended facility is specified, the number of the products being molded in the die per molding cycle is predicted for that facility, and the cost is computed based on them. Furthermore, if only the number of the products being molded in the die per molding cycle is specified, the facility capable of producing the specified number of the products is predicted, and the cost is computed based on them. Furthermore, if both the intended facility and the number of the products being molded in the die per molding cycle are specified, the cost is computed based on them.

More specifically, a field name “INTENDED FACILITY” and a corresponding list box that shows a list of all available facilities retrieved from the manufacturing step database are arranged in the processing type specific dialog menu, and “AUTOMATIC PREDICTION OF INTENDED FACILITY” is also added in the list. The operator can simply select the intended facility from the list box. Furthermore, the “AUTOMATIC PREDICTION OF INTENDED FACILITY” is set as a default name in the list box. The number of the products being molded in the die per molding cycle is also handled in a similar fashion.

The above-described embodiment has the following advantages.

(a) The storage device 21 of the design data server 20 stores the geometrical data and the attribute data of the product produced by the CAD system. The CAD terminal 100 operates as an acquisition device for automatically acquiring values of cost factors of the product from the geometrical data and the attribute data stored in the storage device 21. Furthermore, the CAD terminal 100 also operates as another acquisition device for acquiring at least one of the values of the cost factors through an automatic data acquisition feature of the CAD system upon operation of the CAD system by the operator. The cost estimation server 30 operates as a cost computing device for computing the cost of the product based on the cost factor data acquired by the two acquisition devices. In addition, the CAD terminal 100 operates as a display device for displaying the cost computed by the cost computing device. Thus, by cooperatively operating the CAD system and the cost estimation system, while the product is designed on the CAD system (including both a new design work and a design modification work), the cost estimation system retrieves the design data required for the cost estimation in real time and estimates the cost of the product based on the design data. This allows the operator having no substantial cost estimation expertise to carry out the cost estimation with higher speed and accuracy.

(b) Upon an input operation (e.g., mouse operation) on a displayed three-dimensional CAD screen of the CAD system, values of the cost factors are automatically computed and set in the corresponding cost factor value input fields through the automatic data acquisition feature of the CAD system. More particularly, in the process of acquiring the values of the cost factors through the automatic data acquisition feature of the CAD system, when x, y and z axes of the product are changed, the width, the length and the height of the product are automatically computed and renewed, as shown in FIGS. 11 and 12. Furthermore, as shown in FIGS. 13-15, in the process of acquiring the values of the cost factors, when a couple of points (e.g., any points on straight lines) on the product displayed on the CAD system are selected by a pointing device (e.g., picks the points by the mouse) to set a value of the wall thickness of the product, the wall thickness is computed automatically and is automatically set in the wall thickness value input field.

(c) Each manufacturing step of the product is predicted based on the cost factor data of the manufacturing step specified by the operator, the manufacturing step database and the manufacturing step prediction rules. The cost is computed based on the predicted manufacturing step. The CAD terminal 10 operates as a cost factor specifying device for specifying the cost factor data of the corresponding manufacturing step based on an instruction of the operator. The cost estimation server 30 operates as a manufacturing step prediction device for predicting each manufacturing step of the product based on the cost factor data of the manufacturing step specified by the cost factor specifying device, the manufacturing step database and the manufacturing step prediction rules. The cost estimation server 30 operating as the cost computing device computes the cost based on the predicted manufacturing step.

(d) The storage device 21 of the design data server 20 retrievably stores the cost factor data. With this storage device 21, when the automatic acquisition of the cost factor data is interrupted by manually changing the cost factor data or manually specifying the manufacturing steps, these data can be stored and can be available for later use. Furthermore, with this arrangement, the operator, who cannot use the CAD, is able to conduct the cost estimation by retrieving the stored data through the cost estimation system that is not operated in cooperation with the CAD.

(e) As shown in FIG. 6, the server 30 includes the manufacturing step prediction feature and the cost computation feature. For example, although the cost estimation system operates as one of applications implemented in the CAD system, the manufacturing step prediction part and the cost computation part are implemented in the server to allow the operator, who cannot use the CAD, to use the manufacturing step prediction part and the cost computation part through a client personal computer that is remote from the CAD via a communication line interconnecting the client personal computer to the server. This arrangement allows cooperation between the cost estimation system and the CAD system.

The above-described embodiment can be modified as follows.

Although the cost estimation is carried out for the molded resign product, similar cost estimation can be carried out for the similar processing types, such as die-casting, rubber molding or the like. This can be accomplished by providing another set of the cost factor data of the product, the attribute data of the product, the processing type specific dialog menu and the cost estimation program (the manufacturing step prediction and the cost computation). Then, the corresponding processing type is selected at step 201 of FIG. 5. That is, a process type other than the injection molding is selected on the menu screen shown in FIG. 8, and the operations similar to those discussed in the above-described embodiment are carried out.

Furthermore, a cost of a subassembly product made up of a plurality of components, such as an assembly made up of a rubber hose and an aluminum pipe joined together, can be estimated in a similar way by considering a whole manufacturing process of the subassembly product as one processing type.

Additional advantages and modifications will readily occur to those skilled in the art. The invention in its broader terms is therefore, not limited to the specific details, representative apparatus, and illustrative embodiment shown and described. For instance, the CAD terminal, the design data server and the cost estimation server can be interconnected with each other through a network. The network may includes a global computer network such as the Internet, a local area network, a wide area network, an intranet or extranet, a telephone, cable or satellite network, or other type of network as well as combinations of these and other networks. Furthermore, the CAD terminal, the design data server and the cost estimation server are not necessary separated from each other. For example, the above-described function of the design data server can be integrated into the CAD terminal. Also, the CAD terminal, the design data server and the cost estimation server can be integrated into one computer.

What is claimed is:

1. A method for estimating a cost of a product, comprising steps of:
retrieving and displaying cost factor data of the product, which include cost factors and values of the cost factors, the cost factor data of the product including at least one of geometrical data and attribute data of the product both contained in design data of the product produced by a CAD system, the geometrical data including at least one of dimensions, surface area and volume of the product, and the attribute data including at least product material name;
acquiring at least one of the values of the cost factors by an automatic data acquisition feature of the CAD system through operation of the CAD system conducted by an operator; and
computing cost of the product based on the cost factor data.

2. The method as in claim 1, wherein:
the acquiring step includes an input operation on a displayed three-dimensional CAD screen so that the at least one of the values of the cost factors is computed automatically and set in a corresponding displayed cost factor value input field.

3. The method as in claim 1, wherein:
the dimensions in the cost factors include width, length and height of the product; and
the acquiring step automatically computes, when x, y and z axes of the product displayed on a three-dimensional CAD screen are changed, a value of the width, a value of the length and a value of the height of the product based on the changes and are renewed.

4. The method as in claim 2, wherein:
the dimensions in the cost factors further include wall thickness of the product; and
the acquiring step selects a couple of points on the product being displayed by a pointing device to set a value of the wall thickness of the product, and automatically computes the value of the wall thickness between the points and automatically sets the same in a displayed wall thickness value input field.

5. The method as in claim 1, wherein:
each manufacturing step of the product is predicted based on the cost factor data of the manufacturing step specified by the operator, a manufacturing step database and manufacturing step prediction rules; and
the cost is computed based on the each predicted manufacturing step.

6. The method as in claim 1, wherein:
the cost factor data are retrievably stored in a storage device.

7. A cost estimation apparatus for estimating a cost of a product comprising:
storage device for storing geometrical data and attribute data of the product produced by a CAD system, the geometrical data including at least one of dimensions, surface area and volume of the product, and the attribute data including at least product material name;
a first acquisition device for automatically acquiring values of cost factors of the product from the geometrical data and the attribute data stored in the storage device;
a second acquisition device for acquiring at least one of the values of the cost factors by an automatic data acquisition feature of the CAD system through operation of the CAD system conducted by an operator;
a cost computing device for computing the cost of the product based on cost factor data including the cost factors and the values of the cost factors acquired by the first and second acquisition devices; and
a display device for displaying the cost computed by the cost computing device.

8. The cost estimation apparatus as in claim 7, wherein:
the second acquisition device automatically computes and sets the at least one of the values of the cost factors in a corresponding displayed cost factor value input field, when an input operation on a displayed three-dimensional CAD screen is carried out.

9. The cost estimation apparatus as in claim 7, wherein:
the dimensions include width, length and height of the product; and
the second acquisition device automatically computes and renews a value of the width, a value of the length and a value of the height of the product based on changes, when x, y and z axes of the product displayed on a three-dimensional CAD screen are changed by the operation of the CAD system by the operator.

10. The cost estimation apparatus as in claim 8, wherein:
the dimensions further include wall thickness of the product; and
the second acquisition device automatically computes a value of the wall thickness between a couple of points and automatically sets the computed value of the wall thickness in a displayed wall thickness value input field, when the couple of points on the product being displayed are selected by a pointing device to set the value of the wall thickness of the product.

11. The cost estimation apparatus as in claim 7 further comprising:
a cost factor specifying device for specifying the cost factor data of each manufacturing step based on an instruction of the operator; and
a manufacturing step prediction device for predicting each manufacturing step of the product based on the cost factor data of the manufacturing step specified by the cost factor specifying device, a manufacturing step database and manufacturing step prediction rules,
wherein the cost computing device computes the cost based on the each manufacturing step predicted by the manufacturing step prediction device.

12. The cost estimation apparatus as in claim 7 further comprising:
a storage device for retrievably storing the cost factor data.

13. A cost estimation apparatus for estimating a cost of a product comprising a cost estimation application implemented in a CAD system for computing the cost based on design data of the product produced by the CAD system.

14. The cost estimation apparatus as in claim 13, wherein:
the cost is estimated for the product that is currently displayed on the CAD system.

15. The cost estimation apparatus as in claim 13, further comprising:
a server, which has a manufacturing step prediction feature for predicting each manufacturing step of the product and a cost computation feature for computing the cost of the product.

16. A cost estimation apparatus for estimating a cost of a product comprising:
a CAD machine for designing the product, the CAD machine including a display device for displaying a design of the product and also design data of the product, an input device for inputting the design data and a central processing unit for processing the design data;
a design data server interconnected with the CAD machine and including a storage device for storing the design data and other data transmitted from the CAD machine, wherein the CAD machine is capable of retrieving the design data and other data from the storage device of the design data server;
a cost estimation server for estimating a cost of the product, wherein the cost estimation server is interconnected with the CAD machine and includes a central processing unit for computing the cost of the product based on cost factor data of the product upon receiving an instruction from an operator of the CAD machine through the input device and also includes a storage device for storing the cost factor data and the computed cost of the product,
wherein at least part of the cost factor data of the product is automatically acquired based on the design data by the central processing unit of the cost estimation server,
wherein the cost factor data of the product are concurrently renewed when corresponding input operation is performed on the displayed design of the product by the operator, and
wherein the computed cost of the product is transmitted from the cost estimation server to the CAD machine and is displayed on the display device of the CAD machine.

17. A cost estimation apparatus for estimating a cost of a product comprising:
a CAD machine for designing the product, the CAD machine including a display device for displaying a design of the product and also design data of the product, an input device for inputting the design data, a central processing unit for processing the design data and a storage device for storing the design data; and
a cost estimation server for estimating a cost of the product, wherein the cost estimation server is interconnected with the CAD machine and includes a central processing unit for computing the cost of the product based on cost factor data of the product upon receiving an instruction from an operator of the CAD machine through the input device and also includes a storage device for storing the cost factor data and the computed cost of the product,
wherein at least part of the cost factor data of the product is automatically acquired based on the design data by the central processing unit of the cost estimation server,
wherein the cost factor data of the product are concurrently renewed when corresponding input operation is performed on the displayed design of the product by the operator, and
wherein the computed cost of the product is transmitted from the cost estimation server to the CAD machine and is displayed on the display device of the CAD machine.
